(19) United States
(12) Patent Application Publication
(10) Pub. No.: US 2024/0375194 A1
(43) Pub. Date: Nov. 14, 2024

(54) WHEEL MACHINING DEVICE

(71) Applicant: TOP-ONE MACHINERY CO., LTD., TAICHUNG CITY (TW)

(72) Inventor: Tsui-O Liu, TAICHUNG CITY (TW)

(21) Appl. No.: 18/315,637

(22) Filed: May 11, 2023

(51) Int. Cl. B23C 3/02; B23C 1/06

(52) U.S. Cl. CPC B23C 3/02; B23C 1/06; B23C 2215/085

(57) ABSTRACT

A wheel machining device has a base, at least one 1 longitudinal-driving set, a movable mount, at least one lateral-driving set, a machining set, and a worktable. Each longitudinal-driving set is mounted to the base. The movable mount is connected with the longitudinal-driving set and driven by that to move longitudinally. The lateral-driving set is mounted to the movable mount. The machining set is connected with the lateral-driving set and driven by that to move laterally. The worktable is adjacent to one of two ends of the base. The at least one longitudinal-driving set and the lateral-driving set are assembled with the base which originally occupies a certain space. Therefore, the space utilization of the present invention is promoted.

### BACKGROUND OF THE INVENTION

### 1. Field of the Invention

The present invention relates to a machining device, and more particularly to a wheel machining device that promotes space utilization.

### 2. Description of Related Art

A wheel lathe is a device for finishing or manufacturing wheel frames. A conventional wheel lathe has a spindle for drilling and milling the wheel frames and a worktable for fixing a wheel frame. The worktable of the conventional wheel lathe can longitudinally and laterally move the wheel frame relative to the spindle to finishing parts of the wheel frame.

However, in order to move the wheel frame, the worktable of the conventional wheel lathe has to be equipped with longitudinal-driving device and lateral-driving device. Size of the worktable is increased, overall occupied space of the wheel lathe is enlarged accordingly. Therefore, space utilization of the conventional wheel lathe is low. In addition, the wheel frame fixed to the worktable of the conventional wheel lathe, is raised up by the longitudinal-driving device and the lateral-driving device and is adjacent to the spindle.

Therefore, the conventional wheel lathe cannot machine a wheel frame with a large width. In order to machine the wheel frame with a large width, a position of the spindle has to be increased.

Consequently, the conventional wheel lathe has low space utilization and is difficult to be laid up, boxed, and shipped.

To overcome the shortcomings, the present invention tends to provide a wheel machining device to mitigate or obviate the aforementioned problems.

### SUMMARY OF THE INVENTION

The main objective of the invention is to provide a wheel machining device that promotes space utilization.

A wheel machining device comprises a base, at least one 1 longitudinal-driving set, a movable mount, at least one lateral-driving set, a machining set, and a worktable. Each longitudinal-driving set is mounted to the base. The movable mount is connected with the longitudinal-driving set and driven by that to move longitudinally. The lateral-driving set is mounted to the movable mount. The machining set is connected with the lateral-driving set and driven by that to move laterally. The worktable is adjacent to one of two ends of the base. The at least one longitudinal-driving set and the lateral-driving set are assembled with the base which originally occupies a certain space. Therefore, the space utilization of the present invention is promoted.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a wheel machining device in accordance with the present invention;

FIG. 2 is another perspective view of the wheel machining device in FIG. 1;

FIG. 3 is a partially enlarged perspective view of the wheel machining device in FIG. 1;

FIG. 4 is a partially enlarged perspective view of the wheel machining device in FIG. 1;

FIG. 5 is a side view of the wheel machining device in FIG. 1;

FIG. 6 is a top view of the wheel machining device in FIG. 1; and

FIG. 7 is an enlarged perspective view of the wheel machining device in FIG. 1.

### DETAILED DESCRIPTION OF PREFERRED EMBODIMENT

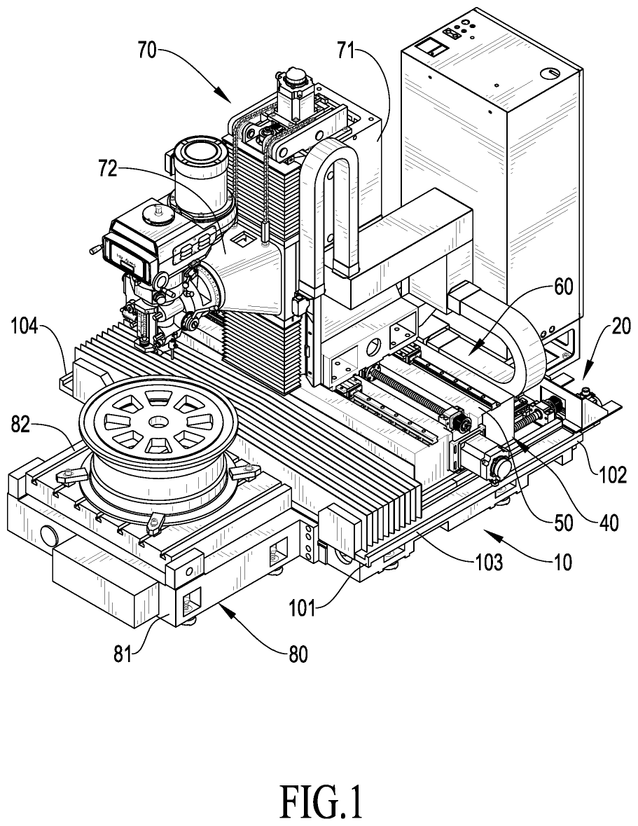

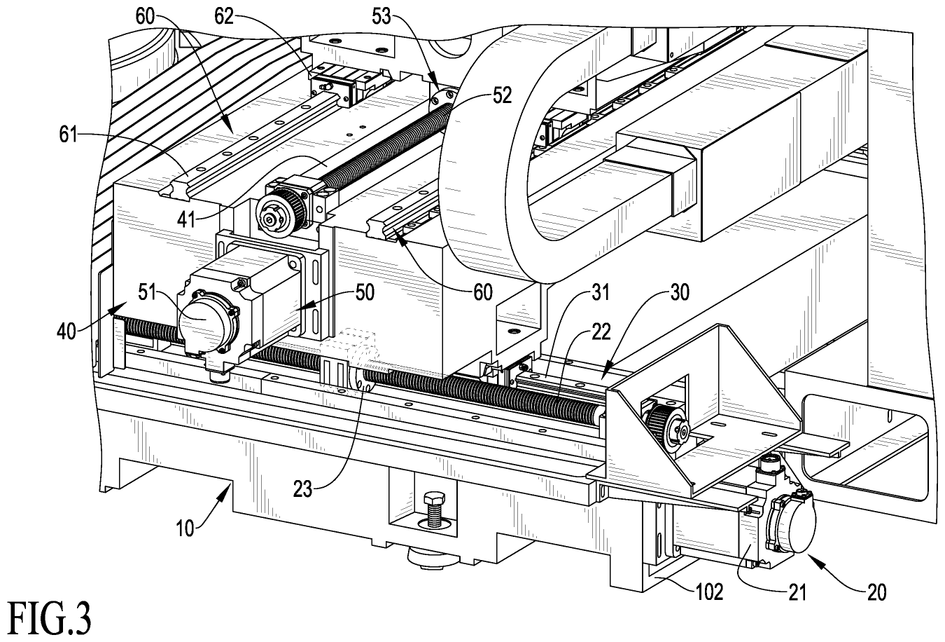

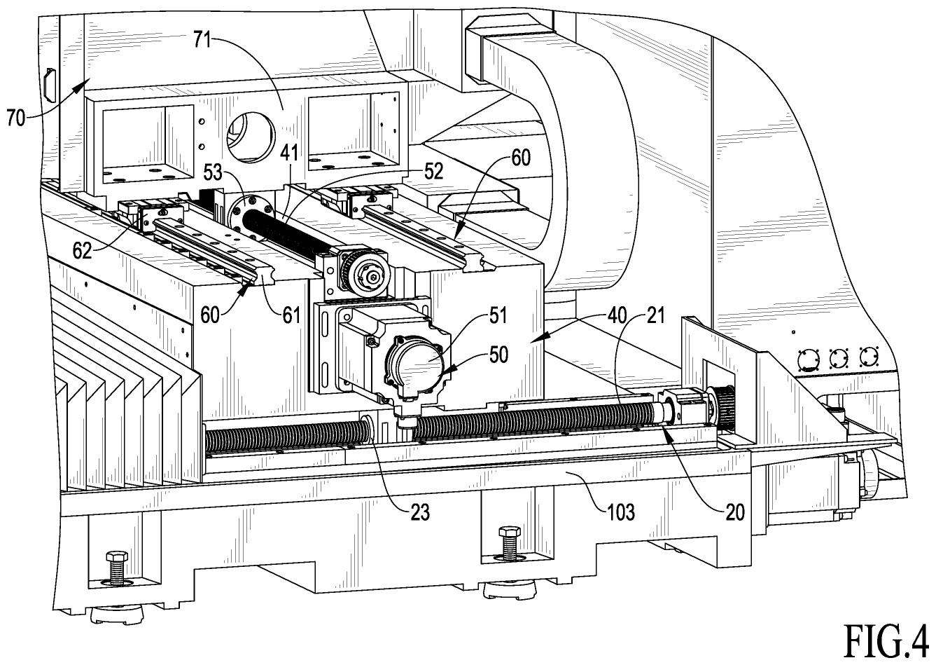

With reference to FIGS. 1 to 4, a wheel machining device in accordance with the present invention has a base 10, two longitudinal-driving sets 20, two longitudinal-moving sets 30, a movable mount 40, a lateral-driving set 50, two lateral-moving sets 60, a machining set 70, and a worktable 80.

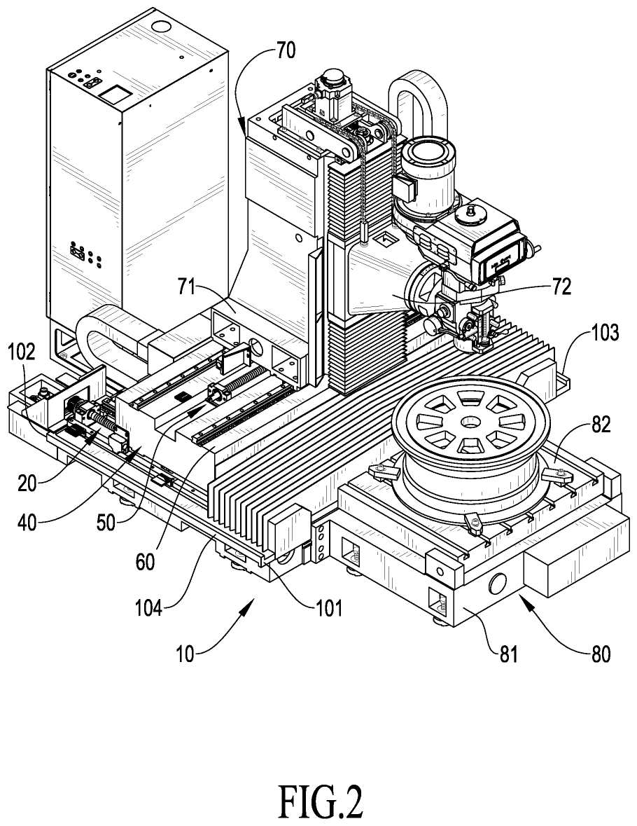

With reference to FIGS. 1 and 2, the base 10 is rectangular and has a first end 101, a second end 102, a first side 103, and a second side 104. The first end 101 and the second end 102 of the base 10 are opposite in position. The first side 103 and the second side 104 of the base 10 are also opposite in position.

With reference to FIGS. 1, 2, and 6, the two longitudinal-driving sets 20 are assembled to the base 10. Each longitudinal-driving set 20 has a longitudinal-driving motor 21, a longitudinal leadscrew 22, and a longitudinal nut 23. Wherein, the longitudinal-driving motor 21 is assembled to the second end 102 of the base 10. The longitudinal leadscrew 22 extends toward the first end 101 and the second end 102 of the base 10 and is connected with the longitudinal-driving motor 21. The longitudinal leadscrew 22 is connected with the base 10 via screw supports and is able to be driven by the longitudinal-driving motor 21 to rotate in place. The longitudinal nut 23 is screwed on the longitudinal leadscrew 22 and able to repeatedly move toward the first end 101 and the second end 102 of the base 10 along the longitudinal leadscrew 22.

With reference to FIGS. 1 to 4, the two longitudinal-moving sets 30 are assembled to the base 10. Each longitudinal-moving set 30 has a longitudinal rail 31 and at least one longitudinal block 32. The longitudinal rail 31 is connected to the base 10 and extends toward the first and second ends 101, 102 of the base 10. Each one of the at least one longitudinal block 32 is mounted to the longitudinal rail 31 and able to slide toward the first and second ends 101, 102 of the base 10 along the longitudinal rail 31. Specifically, the two longitudinal rails 31 are respectively adjacent to the two longitudinal leadscrews 22 of the two longitudinal-driving sets 20.

With reference to FIGS. 1 to 4, the movable mount 40 is connected to the longitudinal nut 23 of each longitudinal-driving set 20 and said longitudinal block 32 of the two longitudinal-moving sets 30. The movable mount 40 is able to repeatedly move toward the first and second ends 101, 102 of the base 10 together with the longitudinal nut 23 of each longitudinal-driving set 20 and the said longitudinal block 32. Specifically, the movable mount 40 has a receiving recession 41 extending toward the first side 103 and the second side 104 of the base 10.

With reference to FIGS. 1 to 4, and 6, the lateral-driving set 50 is assembled to the movable mount 40 and able to move together with the movable mount 40. The lateral-driving set 50 has a lateral-driving motor 51, a lateral leadscrew 52, and a lateral nut 53. The lateral-driving motor 51 is connected to the movable mount 40. The lateral leadscrew 52 extends toward the first side 103 and the second side 104 of the base 10 and is connected with the lateral-driving motor 51. The lateral leadscrew 52 is connected with the movable mount 40 via screw supports, is able to be driven by the lateral-driving motor 51 to rotate in place. Specifically, the lateral leadscrew 52 is disposed within the receiving recession 41 of the movable mount 40. The lateral nut 53 is screwed on the lateral leadscrew 52 and able to repeatedly move toward the first and second sides 103, 104 of the base 10 along the lateral leadscrew 52.

With reference to FIGS. 1 to 4, and 6, the two lateral-moving sets 60 are assembled to the movable mount 40, the receiving recession 41 of the movable mount 40 is disposed between the two lateral-moving sets 60. Each lateral-moving set 60 has a lateral rail 61 and at least one lateral block 62. The lateral rail 61 is connected to the movable mount 40 and extends toward the first and second sides 103, 104 of the base 10. Each of the at least one lateral block 62 is connected to the lateral rail 61 and is able to repeatedly slide toward the first and second sides 103, 104 of the base 10 along the lateral rail 61.

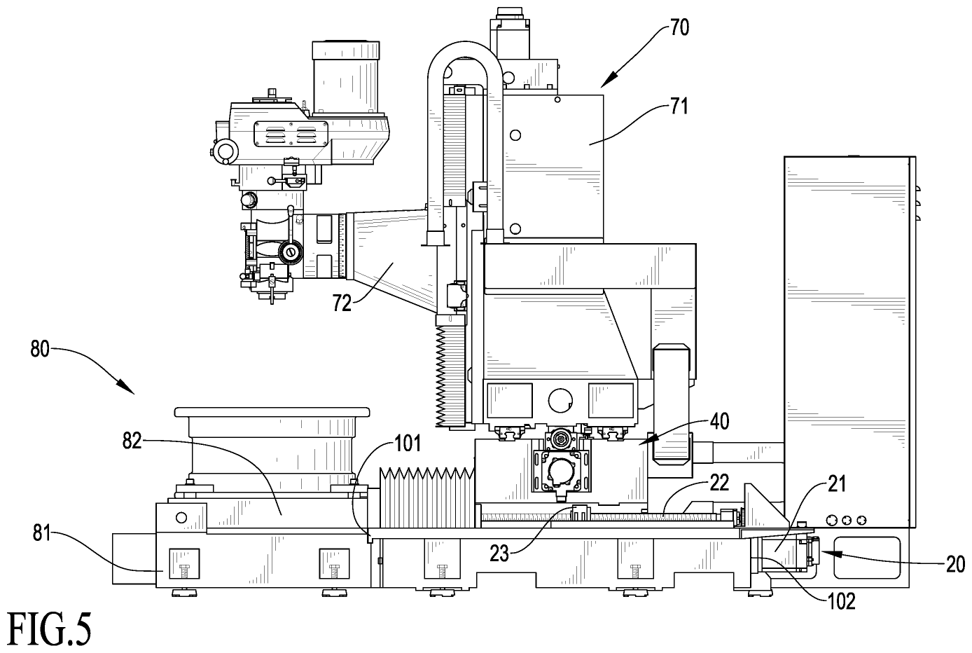

With reference to FIGS. 1, 2, and 5, the machining set 70 has an erect mount 71 and a spindle 72. The erect mount 71 is connected to the lateral nut and said lateral blocks 62 of the two lateral-moving sets 60 and is able to move together with the lateral nut 53 and the said lateral blocks 62. The spindle 72 is connected to the erect mount 71 and is configured to drill or to mill a wheel frame. The spindle 72 may also be equipped with a B-axis milling head.

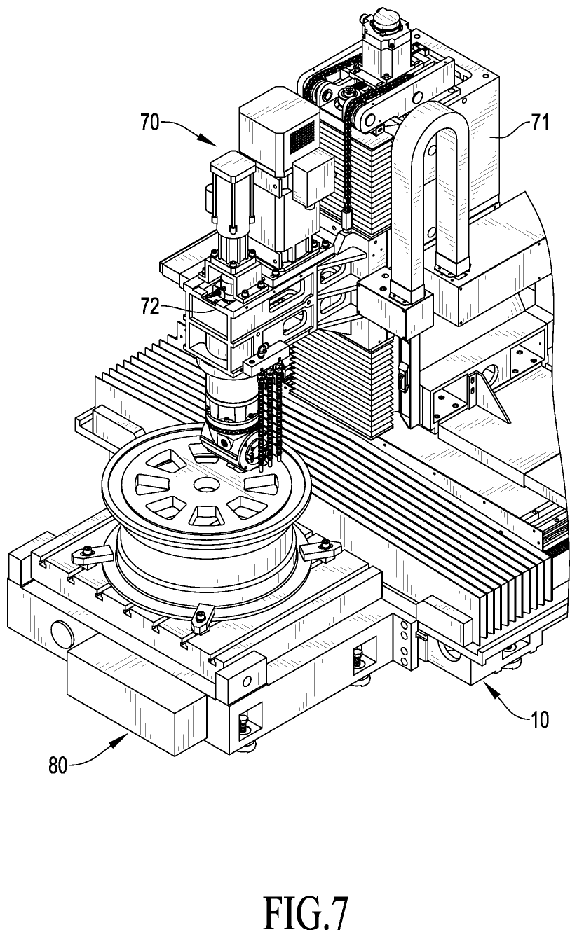

Practically, with reference to FIG. 7, the spindle 72 may be a computer numerical controlled spindle being equipped with a universal milling head. The wheel machining device may has an ATC (automatic tool changer) tool magazine suitable for the spindle being a computer numerical controlled spindle.

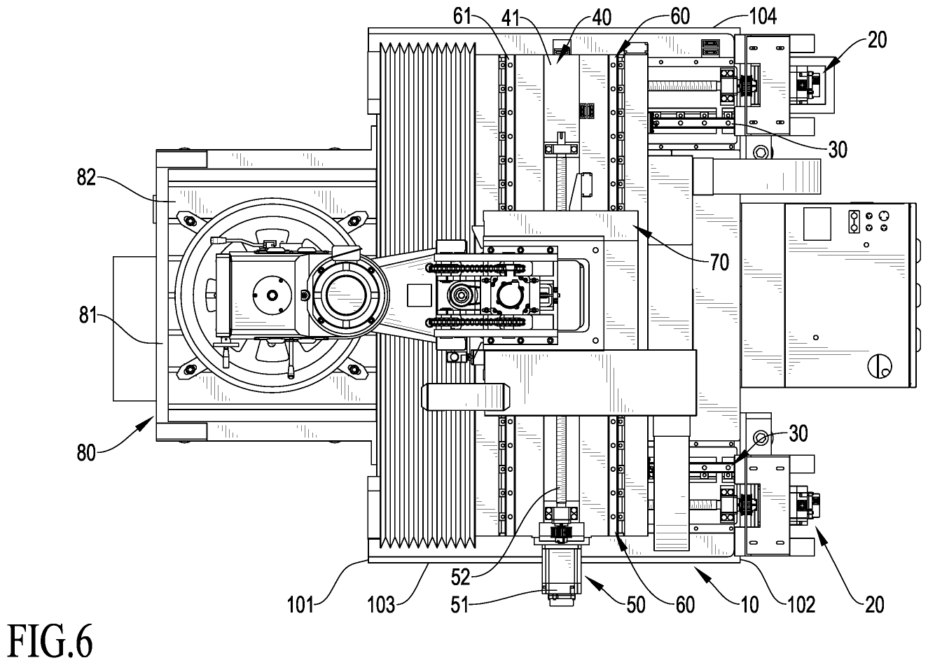

With reference to FIGS. 1 and 6, the worktable 80 has a stand 81 and a platform 82. The stand 81 is disposed adjacent to the first end 101 of the base 10. The platform 82 has four fixtures respectively arranged at four corners of the platform 82 for positioning the wheel frame or other workpieces. The platform 82 has two opposite ends, one of the two opposite ends of the platform 82 is pivotally connected to the stand 81 to let the platform 82 pivot relative to the stand 82 between 0° to 90 degrees. Holes in various directions can be formed in the wheel frame fixed to the platform 82 pivotally connected to the stand 81 by the spindle 72, even a valve stem hole obliquely extending. A motor is connected with the platform 82 and can drive the platform 82 to pivot for changing an included angle defined between the platform 82 and the stand 81.

In the embodiment of the present invention, the longitudinal-driving motor 21 and the longitudinal leadscrew 22 of each longitudinal-driving set 20 are connected via belts and pulleys, the lateral-driving motor 51 and the lateral leadscrew 52 are also connected via belts and pulleys. The longitudinal leadscrew 22 and the lateral leadscrew 52 are supported by the screw supports and can respectively rotate in place. The motor is connected with the platform 82. Detailed assemblies between the longitudinal-driving motor 21 and the longitudinal leadscrew 22, between the lateral-driving motor 51 and the lateral leadscrew 52, and between the motor and the platform 82 are existing technologies and are omitted in the specification of the present invention.

Compared to the conventional wheel lathe having the worktable with longitudinal-driving and lateral-driving devices for moving the wheel frame, in the present invention, the two longitudinal-driving sets 20 and the lateral-driving set 50 are assembled with the base 10 originally occupying a certain space. Therefore, the space utilization of the present invention is promoted.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A wheel machining device comprising:
a base having two opposite ends and two opposite sides;
at least one longitudinal-driving set, each one of the longitudinal-driving set mounted to the base and having
a longitudinal-driving motor;
a longitudinal leadscrew extending toward the two opposite ends of the base, connected to the longitudinal-driving motor, and able to be driven by the longitudinal-driving motor to rotate in place;
a longitudinal nut screwed on the longitudinal leadscrew and able to repeatedly move toward the two opposite ends of the base along the longitudinal leadscrew;
a movable mount connected to the longitudinal nut of each one of the at least one longitudinal-driving set and able to move with the longitudinal nut;
at least one lateral-driving set, each one of the lateral-driving set mounted to the movable mount, able to move with the movable mount, and having
a lateral-driving motor;
a lateral leadscrew extending toward the two opposite sides of the base, connected to the lateral-driving motor, and able to be driven by the lateral-driving motor to rotate in place;
a lateral nut screwed on the lateral leadscrew and able to repeatedly move toward the two opposite sides of the base along the lateral leadscrew;
a machining set having
an erect mount connected to the lateral nut of each one of the at least one lateral-driving set and able to move with the lateral nut; and
a spindle connected to the erect mount; and
a worktable, for fixing a workpiece, disposed adjacent to one of the two opposite ends of the base.

2. The wheel machining device as claimed in claim 1, wherein
the wheel machining device has at least one longitudinal-moving set, each one of the at least one longitudinal-moving set has
a longitudinal rail connected to the base and extending toward the two opposite ends of the base; and
at least one longitudinal block, each one of the at least one longitudinal block mounted to the longitudinal rail, able to repeatedly slide toward the two opposite ends of the base along the longitudinal rail, and connected to the movable mount.

3. The wheel machining device as claimed in claim 2, wherein
the wheel machining device has at least one lateral-moving set, each one of the at least one lateral-moving set has
a lateral rail connected to the base and extending toward the two opposite sides of the base; and
at least one lateral block, each one of the at least one lateral block mounted to the lateral rail, able to repeatedly slide toward the two opposite sides of the base along the lateral rail, and connected to the erect mount.

4. The wheel machining device as claimed in claim 3, wherein
the at least lateral-moving set includes two lateral-moving sets;
the movable mount has a receiving recession disposed between the two lateral-moving sets and extending toward the two opposite sides of the base;
the at least one lateral-driving set includes one lateral-driving set disposed in the receiving recession.

5. The wheel machining device as claimed in claim 1, wherein
the wheel machining device has two longitudinal-moving sets;
each one of the two longitudinal-moving sets has
a longitudinal rail connected to the base and extending toward the two opposite ends of the base; and
at least one longitudinal block mounted to the longitudinal rail and able to repeatedly slide toward the two opposite ends of the base along the longitudinal rail; and
the at least one longitudinal-driving set includes two longitudinal-driving sets;
two rails of the two longitudinal-moving sets are respectively adjacent to two longitudinal leadscrews of the two longitudinal-driving sets.

6. The wheel machining device as claimed in claim 1, wherein
the wheel machining device has two lateral-moving sets;
each one of the two lateral-moving sets has
a lateral rail connected to the movable mount and extending toward the two opposite sides of the base; and
at least one lateral block mounted to the longitudinal rail and able to repeatedly slide toward the two opposite sides of the base along the lateral rail.

7. The wheel machining device as claimed in claim 1, wherein the spindle is a computer numerical controlled spindle and is equipped with a universal milling head.

8. The wheel machining device as claimed in claim 7, wherein the wheel machining device has an ATC (automatic tool changer) tool magazine suitable for the spindle.

9. The wheel machining device as claimed in claim 1, wherein the spindle is equipped with a B-axis milling head.

10. The wheel machining device as claimed in claim 1, wherein
the worktable has
a stand disposed adjacent to one of the two opposite ends of the base;
a platform having two opposite ends, one of the two opposite ends of the platform pivotally connected to the stand to let the platform pivot relative to the stand between 0° to 90° degrees.

11. The wheel machining device as claimed in claim 2, wherein
the worktable has
a stand disposed adjacent to one of the two opposite ends of the base;
a platform having two opposite ends, one of the two opposite ends of the platform pivotally connected to the stand to let the platform pivot relative to the stand between 0° to 90° degrees.

12. The wheel machining device as claimed in claim 3, wherein
the worktable has
a stand disposed adjacent to one of the two opposite ends of the base;
a platform having two opposite ends, one of the two opposite ends of the platform pivotally connected to the stand to let the platform pivot relative to the stand between 0° to 90° degrees.

13. The wheel machining device as claimed in claim 4, wherein
the worktable has
a stand disposed adjacent to one of the two opposite ends of the base;
a platform having two opposite ends, one of the two opposite ends of the platform pivotally connected to the stand to let the platform pivot relative to the stand between 0° to 90° degrees.

14. The wheel machining device as claimed in claim 5, wherein
the worktable has
a stand disposed adjacent to one of the two opposite ends of the base;
a platform having two opposite ends, one of the two opposite ends of the platform pivotally connected to the stand to let the platform pivot relative to the stand between 0° to 90° degrees.

15. The wheel machining device as claimed in claim 6, wherein
the worktable has
a stand disposed adjacent to one of the two opposite ends of the base;
a platform having two opposite ends, one of the two opposite ends of the platform pivotally connected to the stand to let the platform pivot relative to the stand between 0° to 90° degrees.

16. The wheel machining device as claimed in claim 7, wherein
the worktable has
a stand disposed adjacent to one of the two opposite ends of the base;
a platform having two opposite ends, one of the two opposite ends of the platform pivotally connected to the stand to let the platform pivot relative to the stand between 0° to 90° degrees.

17. The wheel machining device as claimed in claim 8, wherein
the worktable has
a stand disposed adjacent to one of the two opposite ends of the base;
a platform having two opposite ends, one of the two opposite ends of the platform pivotally connected to the stand to let the platform pivot relative to the stand between 0° to 90° degrees.

18. The wheel machining device as claimed in claim 9, wherein
the worktable has
a stand disposed adjacent to one of the two opposite ends of the base;
a platform having two opposite ends, one of the two opposite ends of the platform pivotally connected to the stand to let the platform pivot relative to the stand between 0° to 90° degrees.
